(19) United States
(12) Patent Application Publication
(10) Pub. No.: US 2025/0059348 A1
(43) Pub. Date: Feb. 20, 2025

(54) BIODEGRADABLE COMPOSITES

(71) Applicant: YEDA RESEARCH AND DEVELOPMENT CO. LTD., Rehovot (IL)

(72) Inventors: Boris RYBTCHINSKI, Givaataim (IL); Angelica ELKAN, Rehovot (IL); Haim WEISSMAN, Rehovot (IL); Ariel ODESS, Rehovot (IL)

(73) Assignee: YEDA RESEARCH AND DEVELOPMENT CO. LTD., Rehovot (IL)

(21) Appl. No.: 18/720,785

(22) PCT Filed: Dec. 22, 2022
(86) PCT No.: PCT/IL2022/051375

§ 371 Date: Jun. 17, 2024

(30) Foreign Application Priority Data
Dec. 22, 2021 (IL) 289286

(51) Int. Cl. C08K 5/17; C08B 11/02; C09D 7/63; C09D 101/28

(52) U.S. Cl. CPC C08K 5/175; C08B 11/02; C09D 7/63; C09D 101/28; C08K 2201/011; C08K 2201/018

(57) ABSTRACT

Provided herein a biodegradable composite comprising a biodegradable polymer and bio-crystals, wherein the bio-crystals are in a concentration of between 1 wt % to 50 wt % of the biodegradable polymer.

### FIELD OF THE INVENTION

Provided herein a biodegradable composite comprising a biodegradable polymer and bio-crystals, wherein the bio-crystals are in a concentration of between 1 wt % to 50 wt % of the biodegradable polymer. Specifically, the composite comprises 2-hydroxyethyl cellulose (HEC) and L-tyrosine crystals.

### BACKGROUND OF THE INVENTION

There is a crucial need for sustainable and environmentally friendly alternative for synthetic plastic materials due to the destructive effect of plastic waste on soil and water resources. Currently, about 39% of annually produced synthetic polymers are utilized by the packaging industry, thus it is the largest industry of plastics, and a major contributing factor to waste generation on a global level. Most packages are disposable, yet the polymers that are used for packaging are resistant to most natural processes of degradation, resulting in accumulation of debris polluting the soil and water resources. Furthermore, in the natural environment, plastic debris undergoes fragmentation into microplastics, that persist in the environment, particularly in the aquatic and marine ecosystem, further increasing the challenge in plastic waste management.

Bioplastics emerge as the alternative platform to the petroleum based synthetic polymers, since the production of biobased polymers consumes less energy and reduces the emission of greenhouse gases. Furthermore, biodegradable polymers are produced from renewable sources, and are prone to eco-friendly degradation.

Biopolymer based materials may be classified into three main types based on their origin and synthesis. (i) Polymers which are directly extracted or removed from biomass such as starch, cellulose, and proteins. Currently, starches and protein-based polymers are implemented as blends with synthetic polymers due to their poor mechanical properties; (ii) Polymeric materials which are synthesized using renewable biobased monomers, such as Polylactic acid (PLA), Polyglycolic acid (PGA) and polycaprolactone (PCL). While having a good chemical and mechanical stability in ambient environment, PLA undergoes biodegradation in specific conditions thus PLA debris should be delivered to plants that specialize in its degradation. All other forms of disposal result in accumulation similar to a non-degradable plastic; (iii) The third type of biobased polymers are produced by microorganisms, mainly polyhydroxy-alkanoates such as Polyhydroxybutyrate (PHB). This type requires bacterial growth in a controlled environment which severely restricts the scale of production.

Still about 99% of all plastic materials are manufactured by synthetic polymers due to their low cost and superior physical and mechanical properties.

There is a need for improved sustainable and environmentally friendly alternative for synthetic plastic materials.

### SUMMARY OF THE INVENTION

In some embodiments, provided herein a biodegradable composite comprising a biodegradable polymer and bio-crystals, wherein the bio-crystals are in a concentration of between 1 wt % to 50 wt % of the biodegradable polymer.

In some embodiments, this provided herein a biodegradable composite comprising a hydroxyethyl cellulose (HEC), and L-tyrosine crystals, wherein the L-tyrosine is in a concentration of between 1 wt % to 50 wt % within the biodegradable polymer. In other embodiments, the L-tyrosine crystals are dispersed homogeneously within the polymer.

In some embodiments, provided herein a biodegradable composite comprising agar polymer, and L-tyrosine crystals, wherein the L-tyrosine is in a concentration of between 1 wt % to 50 wt % within the biodegradable polymer. In other embodiments, the L-tyrosine crystals are dispersed homogeneously within the polymer.

In some embodiments, the composite provided herein has improved mechanical properties compared to the biodegradable polymer alone.

In some embodiments, provided herein an encapsulated composite, wherein the composite comprises a biodegradable polymer and bio-crystals, wherein the bio-crystals are in a concentration of between 1 wt % to 50 wt % of the biodegradable polymer. In other embodiments, the composite is encapsulated by hydrophobic polymer.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A and 1B: SEM images of Tyr. FIG. 1A: Needle like crystals of Tyr in the pristine film. Inset: photography of the film. FIG. 1B: Zoom in to FIG. 1A.

FIGS. 2A-2D: SEM imaging of freshly prepared HEC/Tyr composite at initial (FIG. 2A), after 30 min (FIG. 2B), after 60 min (FIG. 2C) and after 90 min (FIG. 2D).

FIGS. 3A-3D. FIG. 3A—a photograph of HEC/Tyr hybrid film. FIG. 3B—a photograph of the neat HEC film. FIG. 3C—light microscopy image of the HEC/Tyr hybrid, the crystalline needles of Tyr are clearly visible with isotropic homogeneous distribution. FIG. 3D—cross polarized microscopy image, Tyr crystals are the light lines.

FIGS. 4A-4D: SEM image of HEC/Tyr hybrid film. FIG. 4A—Top view of the composite film. FIG. 4B—Zoom into (FIG. 4A). Tyr fibers have isotropic orientation. FIG. 4C—Cross-section of the composite film. FIG. 4D—Zoom into (FIG. 4C). The Tyr crystals were evenly distributed throughout the polymer matrix.

FIGS. 5A-5G: FIG. 5A—SEM images of the hybrid films after tensile failure test showing that there is no phase separation or disentanglement between the crystals and the polymer upon tensile starch. FIGS. 5B-5E—SEM images of the failure cross-section of HEC and Tyr hybrid. The failure mechanism involves breaking of the Tyr crystals and rapture of HEC simultaneously as evident from the sharp rapture pattern of the HEC polymer. FIG. 5F—Cross section of the hybrid films after tensile failure. FIG. 5G—Cross section of the pristine HEC film after failure.

FIGS. 6A-6D: Cryo-SEM image of HEC/Tyr hybrid gel. FIG. 6A —Top view of the composite film. FIG. 6B—Cross-section of the composite film, the polymer matrix is marked with dashed arrows, while the crystals are marked with black arrows. FIG. 6C—Zoom in to (FIG. 6A) top view, Tyr fibers (marked in arrow) are wrapped by HEC polymer matrix (lacelike structure). FIG. 6D—showing Tyr fibers (black arrow) interconnected by the polymer matrix.

FIGS. 7A-7F: Representative stress-strain curve of HEC/Tyr hybrids. FIG. 7A—neat HEC film. FIG. 7B—HEC/Tyr; 100/10 mg. FIG. 7C—HEC/Tyr; 100/20 mg. FIG. 7D—HEC/Tyr; 100/30 mg. FIG. 7E—HEC/Tyr; 100/40 mg. FIG. 7F—HEC/Tyr; 100/50 mg.

FIGS. 8A-8B: FIG. 8A—SEM imaging of: Aggregate boundle of Tyr crystals.

FIG. 8B—Tyr crystal that are grown from supersaturated solution, followed by insonation to prevent coagulation.

FIGS. 9A-9D: SEM images HEC/Tyr foam. FIG. 9A—Cross-section along the rectangular section. Inset: photography of the cylindrical hybrid foam. The cylindrical section is shown in FIG. 5B Magnified image showing fibrous Tyr crystal embedded in the polymer matrix (dashed arrow) and the coiled bundles of Tyr that appear in the freshy prepared hybrids are marked by black arrows. Inset: Coiled bundles of Tyr crystal primers in the freshy prepared hybrids (Also shown in FIG. 2A). FIG. 9C—Interconnected network of HEC/Tyr hybrid. FIG. 9D—Zoom into (FIG. 9C) where the crystal fibers were clearly visible.

FIGS. 10A-10B: XRD diffractograms of: FIG. 10A—Films of Pristine Tyrosine, Pristine HEC and HEC/Tyr hybrids. FIG. 10B—Hybrid foam.

FIGS. 11A-11B: Photograph of PCL/HEC/Tyr protected films: FIG. 11A-Ambient conditions. FIG. 11B—After immersing the film in water for 24h.

FIGS. 12A-12E: TGA Analysis of the HEC/Tyr hybrid. FIG. 12A—PCL/HEC polymer blend; 50/10 mg. FIG. 12B—PCL/HEC/Tyr; 50/100/20 mg. FIG. 12C—PCL/HEC/Tyr;50/100/30 mg. FIG. 12D—HEC/Tyr; 50/100/40 mg. FIG. 12E—PCL polymer film.

FIGS. 13A-13E: FIG. 13A—Photography of Agar/Tyr hybrid film. FIG. 13B—SEM image of the Top view of Agar/Tyr hybrid, the crystalline needles of Tyr are clearly visible with isotropic homogeneous distribution. FIG. 13C—Cross-section of the composite film. The Tyr crystals are evenly distributed throughout the polymer matrix. FIG. 13D—Characteristic stress-strain curve of pristine agarose film and Agar/Tyr; 100/20 mg hybrid. FIG. 13E—XRD diffractogram of the Agar/Tyr hybrid, showing characteristic Tyr peaks with mostly amorphous Agar matrix.

FIG. 14: Presents the effect of tyrosine crystal growth within Alginate on the compression modulus (open circles and “×” single) compared to neat Alginate (square and triangle): Alginate with tyrosine crystals mixed with the alginate solution before cross linking (dash line); alginate solution added to Tyrosine hydrogel before crosslinking (plus sign “+”). The dark circles: Tyrosine crystal/alginate that was frozen after a few minutes (before the Tyrosine crystals were fully developed). (See Example 5)

FIG. 15: Presents the effect of the crystal growth of Tyrosine on the aerogel strength is demonstrated by the increasing of the compression modulus by the increasing the time of developing before stopping crystal growth (by freezing). In the Inset a picture of the Tyrosine aerogel.

FIGS. 16A-16B: presents XRD (FIG. 16A) and SEM (FIG. 16B) data supporting the existence of larger and more developed crystals of Tyrosine at longer crystallization time as Tyrosine aerogel.

FIG. 17: A photograph of a Tyr/PCL aerogel with the density of 95 mg/cm3 (Example 5).

FIG. 18: presents biodegradation of Composite 1 (Tyr/Hec) and Composite 2 (PCL/Tyr/Hec) expressed as released CO₂ (mg) (Example 6).

FIG. 19: presents biodegradation of Composite 1 (Tyr/Hec) and Composite 2 (PCL/Tyr/Hec) expressed by % of biodegradability (Example 6).

It will be appreciated that for simplicity and clarity of illustration, elements shown in the Figures have not necessarily been drawn to scale. For example, the dimensions of some of the elements may be exaggerated relative to other elements for clarity. Further, where considered appropriate, reference numerals may be repeated among the Figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Biopolymer based bioplastics are the most attractive candidates for disposable materials application, as the use of biodegradable and compostable bioplastics prevents the accumulation of durable plastic debris.

This disclosure provides a new method for casting bioplastic materials based on hybridization of ductile polymer matrix with highly robust molecular crystals, which may give rise to both strong and ductile bioplastic materials that are based on readily available green building blocks. The hybridization had a synergistic effect and yielded material with upgraded mechanical properties comparing to the neat components. The amount of the molecular crystals in the polymer matrix is variable and controllable, so the properties of the hybrid can be modified. Furthermore, the hybrid is biodegradable and compostable.

This disclosure provides bioplastic composites, tunable materials that are constructed from biodegradable polymer matrix coupled with biomolecular crystals. Biomolecular crystals are mechanically and thermally robust, thus their hybrids with polymer matrix rival or overperform conventional biopolymers.

In some embodiments, provided herein a biodegradable composite/hybrid comprising a biodegradable polymer and bio-crystals, wherein the bio-crystals are in a concentration of between 1 wt % to 50 wt % of the biodegradable polymer.

In some embodiments, provided herein a biodegradable composite comprising a biodegradable polymer and bio-crystals, wherein the bio-crystals are about 1 wt %, 2 wt %, 3 wt %, 4 wt %, 5 wt %, 10 wt %, 20 wt %, 30 wt %, 40 wt % or 50 wt % of the biodegradable polymer, or any ranges thereof. In other embodiments, the biocrystals are in a concentration of between 1 wt % and 50 wt %, between 1 wt % and 20 wt %, between 1 wt % and 10 wt %, between 5 wt % and 10 wt %, between 7 wt % and 15 wt %, between 10 wt % and 20 wt %, between 10 wt % and 30 wt %, between 10 wt % and 40 wt %, between 10 wt % and 50 wt %, or between 20 wt % and 50 wt %.

In some embodiments the biodegradable polymer and the bio-crystals form a hybrid. The terms “composite” and “hybrid” are used herein interchangeably.

In some embodiments, the biodegradable composite provided herein comprises a biodegradable polymer, wherein the polymer comprises 2-hydroxyethyl cellulose (HEC), cellulose, cellulose derivative, cellulose acetate, poly(lactic acid) (PLA), poly(L-lactic acid)(PLLA), poly(D-lactic acid)(PDLA), racemic PLA, poly(glycolic acid) (PGA), PLA/PGA, Chitosan, thermoplastic starch (TPS)/polystyrene, TPS/low density polyethylene (LDPE), TPS/bacterial cellulose, agarose (Agar) polysaccharide, Polyhydroxybutyrate(PHB), or any combination thereof. In other embodiments, the wherein the biodegradable polymer is 2-hydroxyethyl cellulose (HEC).

In some embodiments, the biodegradable composite disclosed herein comprises bio-crystals, wherein the bio-crystals comprise uric acid, amino acids, purine, guanine, xanthenes, isoxanthenes, indigo, porphyrin or any combination thereof. In other embodiments, the bio-crystals comprise uric acid. In other embodiments, the bio-crystals comprise amino acids. In other embodiments, the bio-crystals comprise purine. In other embodiments, the bio-crystals comprise guanine. In other embodiments, the bio-crystals comprise xanthenes. In other embodiments, the bio-crystals comprise isoxanthenes. In other embodiments, the bio-crystals comprise indigo. In other embodiments, the bio-crystals comprise porphyrin. In other embodiments, the bio-crystals are amino acids. In other embodiments, the amino acid is L-amino acid, D-amino acid or a racemate. In other embodiments, the amino acid is tyrosine or phenylalanine. In other embodiments the tyrosine is L-tyrosine, D-tyrosine or tyrosine racemate. In other embodiments, the bio-crystals provided herein are nanocrystals (i.e., havening a diameter of between 10 nanometers to 1000 nanometers or microcrystals (i.e., having a diameter of between 1 micron to 100 microns). In other embodiments the bio-crystals provided herein have a diameter of between 50 nm and 100 microns. In other embodiments, the size of the diameter of the bio crystals is between 50 nm and 1 micron. In other embodiments, the size of the diameter of the bio crystals is between 50 nm and 500 nm. In other embodiments, the size of the diameter of the bio crystals is between 50 nm and 1 micron. In other embodiments, the size of the diameter of the bio crystals is between 50 nm and 10 microns. In other embodiments, the size of the diameter of the bio crystals is between 1 micron and 100 microns.

In some embodiments, the biodegradable composite provided herein comprises HEC and tyrosine crystals. In some embodiments, the biodegradable composite provided herein comprises HEC and tyrosine nanocrystals. In other embodiments the tyrosine is L-tyrosine.

HEC is a derivative of cellulose. Etherification of cellulose by ethylene oxide yields a water-processable non crystalline polysaccharide with high ductility. However, HEC is soft and has a low elastic resilience, therefore it is mostly used in soft matter applications such as lubrication and drug capsule formulation. The hybridization of HEC with an amino acid such as tyrosine (Tyr) was carried out by simple mixing of the precursors in aqueous medium. First, Tyr was dissolved in boiling water, the filtered solution was added to the aqueous solution of HEC, then the mixture was stirred in ambient temperature to allow the crystallization of Tyr within the polymer matrix.

2-hydroxyethyl cellulose (HEC), with the bio-crystals of the amino acid Tyrosine (Tyr), exhibits synergistic upgraded mechanical properties comparing to the parent components (Example 2). In other embodiments, the tyrosine is L-tyrosine.

Tyr is a unique amino acid as its water solubility is very low (0.45 mg/ml at 25° C.) due to the robust crystal structure, each Tyr unit is interconnected with 3D hydrogen bonds.

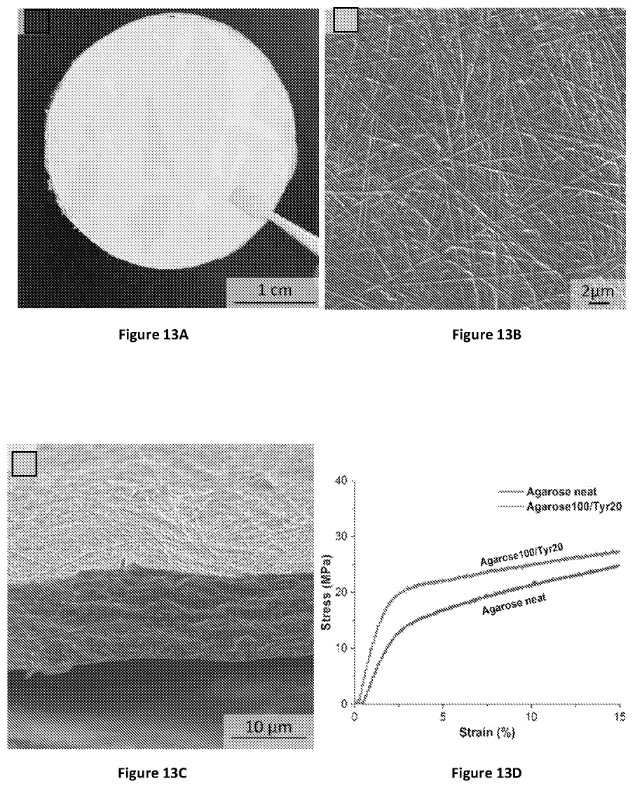

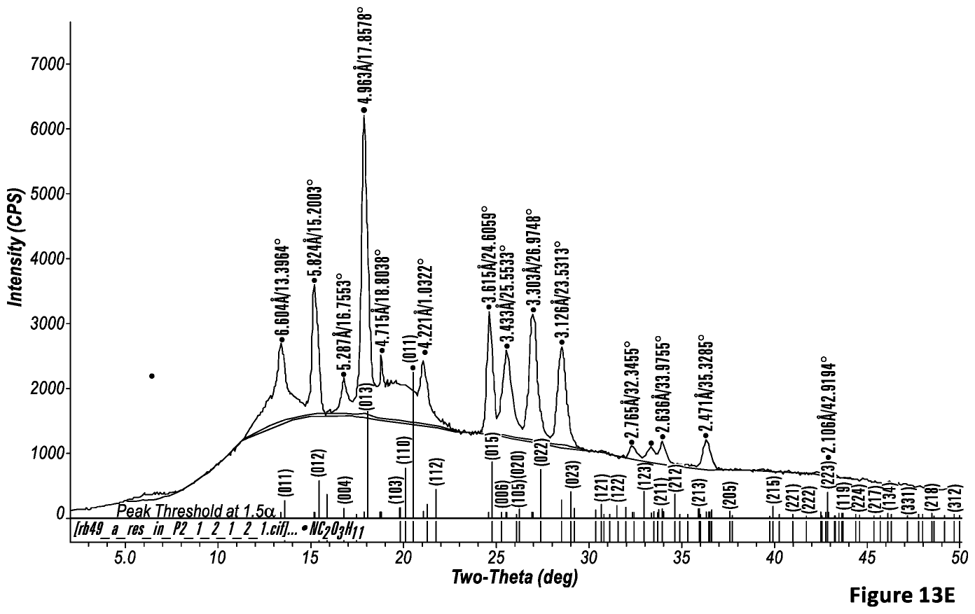

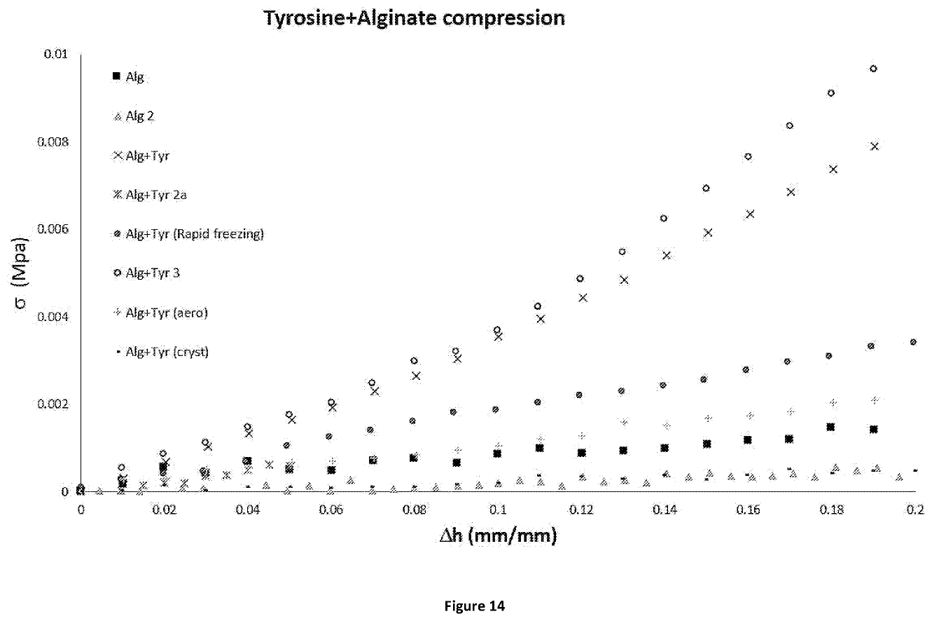

In some embodiments, the biodegradable composite provided herein comprises agar and tyrosine crystals. In some embodiments, the biodegradable composite provided herein comprises agar and tyrosine nanocrystals. In other embodiments, the Agar/Tyr yields homogeneous hybrids with enhanced mechanical robustness (Example 4, FIGS. 13A-13E). In other embodiments, the tyrosine is L-tyrosine.

In some embodiments, the composite provided herein comprises a biodegradable polymer and bio-crystals, wherein the bio-crystals are dispersed homogeneously within the biodegradable polymer. In some embodiments, the composite provided herein comprises a biodegradable polymer and bio-crystals, wherein the bio-crystals having a diameter between 50 nm and 100 microns are dispersed homogeneously within the biodegradable polymer.

In some embodiments, the composite provided herein comprises a biodegradable polymer and bio-crystals, wherein the composite is stable at a temperature up to 200° C. deg. In other embodiments, the composite degrades/compostable after between 14 days to 30 days.

In some embodiments, the composite degrades/compostable by 15%-50 wt % after 30 days. In some embodiments, the composite degrades/compostable by 30%-50 wt % after 30 days. In some embodiments, the composite degrades/compostable by 30%-100 wt % after 30 days. In some embodiments, the composite degrades/compostable by 50%-100 wt % after 30 days. In some embodiments, the composite degrades/compostable by at least 20 wt % after 30 days. In some embodiments, the composite degrades/compostable by at least 50 wt % after more than 30 days, 60 days or 90 days. In some embodiments, the composite degrades/compostable by at least 30 wt % after more than 30 days, 60 days or 90 days.

In some embodiments, all the components of the composite are biodegradable, and all the hybrids are compostable. A qualitative observation of the biodegradation in domestic composter was performed; no visible residue of the unprotected films was observed within one month. (A film of 30×10 cm; 40-50 micron thick).

To reduce the water susceptibility of the composite, the composite is encapsulated with hydrophobic polymer as a protection layer, the composite preserves composability with good mechanical performance.

In some embodiments, the composite disclosed herein comprises a biodegradable polymer and bio-crystals, wherein the composite is further encapsulated by hydrophobic film. In other embodiments, the hydrophobic film comprises polycaprolactone (PCL). In other embodiments, the encapsulation is prepared as described in Example 3. In other embodiments, the encapsulated composite maintains the same mechanical properties as the non-encapsulated composite. The mechanical properties of encapsulated and non-encapsulated composite are the same in terms of their maximal tensile stress, modulus and toughness, wherein the term “the same” refers to maximal tensile stress being between ±1-20%, ±1-10% or ±1-5%, for both encapsulated or non-encapsulated composite; or to modulus being between ±1-20%, ±1-10% or +1-5%, for both encapsulated or non-encapsulated composite; or to toughness being between ±1-20%, ±1-10% or +1-5%, for both encapsulated or non-encapsulated composite. The concept of composing hybrid biopolymers is unique. Readily available and fully biodegradable polymer matrixes (HEC, agar, PCL) that originally have a very poor mechanical properties and are known to be implemented only in the field of soft materials and emulsifiers, surprisingly, provided herein increased both the strength and toughness the composites provided herein and provided stiffness to the polymers.

Furthermore, surprisingly, the use of amino acid crystals provided stiffness and increase the strength of soft and ductile polymers.

### Mechanical Properties of the Composite Disclosed Herein

In some embodiments, this disclosure provides a biodegradable composite comprising a biodegradable polymer and bio-crystals, wherein the bio-crystals are in a concentration of between 1 wt % to 50 wt % of the biodegradable polymer, wherein the composite provides improved mechanical compared to the polymer alone. The improved mechanical properties of the composite provided herein comprises improved maximal tensile stress, modulus, toughness or combination thereof compared to the biodegradable polymer alone.

In some embodiments the composite provides a mechanical properties comprising improved maximal tensile stress, modulus or toughness or combination thereof compared to the biodegradable polymer, wherein the modulus is improved by 2 to 6 times compared to the biodegradable polymer; the toughness is increased by 1.5 to 5 times compared to the biodegradable polymer; and elongation is improved up to 2-4 times compared to the biodegradable polymer.

In some embodiments the composite provides a mechanical properties comprising improved maximal tensile stress, modulus, toughness or combination thereof compared to the biodegradable polymer, wherein the modulus is improved by 2, 3, 4, 5 or 6 times compared to the biodegradable polymer; the toughness is increased by 1.5, 2, 3, 4 or 5 times compared to the biodegradable polymer; and elongation is improved by 2, 3 or 4 times compared to the biodegradable polymer.

In some embodiments the encapsulated composite provided herein comprises mechanical properties comprising improved maximal tensile stress, modulus, toughness or combination compared to the biodegradable polymer, wherein the modulus is improved by 2 to 6 times compared to the biodegradable polymer; the toughness is increased by 1.5 to 5 times compared to the biodegradable polymer; and elongation is improved up to 2-4 times compared to the biodegradable polymer.

### Uses of the Composite Disclosed Herein

In some embodiments, provided herein is a film comprising a composite comprising a biodegradable polymer and bio-crystals, wherein the bio-crystals are in a concentration of between 1 wt % to 50 wt % of the biodegradable polymer.

In some embodiments, provided herein is a foam comprising a composite comprising a biodegradable polymer and bio-crystals, wherein the bio-crystals are in a concentration of between 1 wt % to 50 wt % of the biodegradable polymer.

In some embodiments, provided herein is a hydrogel comprising a composite comprising a biodegradable polymer and bio-crystals, wherein the bio-crystals are in a concentration of between 1 wt % to 50 wt % of the biodegradable polymer.

In some embodiments, provided herein is an aerogel comprising a composite comprising a biodegradable polymer and bio-crystals, wherein the bio-crystals are in a concentration of between 1 wt % to 50 wt % of the biodegradable polymer.

In some embodiments, provided herein a 3D product comprising a composite comprising a biodegradable polymer and bio-crystals, wherein the bio-crystals are in a concentration of between 1 wt % to 50 wt % of the biodegradable polymer. In other embodiments, the film, aerogel, hydrogel, a gel, xerogel, or a bulk 3D structure or the foam provided herein is used as a packaging material, a coating material, structural/construction material (e.g., for automotive industry, 3D printer, plastics, automobile), any known uses for plastics.

In some embodiments, this invention provides a construction material, wherein the construction material comprises a composite comprising a biodegradable polymer and bio-crystals, wherein the bio-crystals are in a concentration of between 1 wt % to 50 wt % of the biodegradable polymer wherein the composite reinforces the construction material compared to using the biodegradable polymer alone.

In another embodiment, the composite provided herein is embedded within the construction material. In another embodiment, the construction material is coated by the composite. In other embodiments, the construction material comprises concrete, a gypsum polyethylene, polypropylene, ABS, nylons, polystyrene, polyvinyl chloride, polylactic acid, polyurethanes, polyester, epoxy resin, poly acrylates, PEEK or any polymer that can be used in a 3D printer, plastics, automobile, and their combination and/or copolymers.

In some embodiments, the composite provided herein is used for the preparation of construction material.

In some embodiments the composites provided herein are prepared in organic solutions, by melt extrusion or melt compounding. In other embodiments, prepared by extrusion.

In other embodiments, provided herein a method for the preparation of the composites of this invention, wherein the composites are prepared by melt extrusion or by melt compounding.

In some embodiments, provided herein is a biodegradable packaging material comprising a composite comprising a biodegradable polymer and bio-crystals, wherein the bio-crystals are in a concentration of between 1 wt % to 50 wt % of the biodegradable polymer.

In some embodiments, provided herein is a coating material comprising a composite comprising a biodegradable polymer and bio-crystals, wherein the bio-crystals are in a concentration of between 1 wt % to 50 wt % of the biodegradable polymer.

The following examples are presented in order to more fully illustrate the preferred embodiments of the invention. They should in no way, however, be construed as limiting the broad scope of the invention.

### EXAMPLES

### Methods

Scanning electron microscope (SEA) Imaging was performed using a Zeiss Supra 55 FEG-SEM or Ziess Ultra 55 FEG-SEM operating at 1-20 kV. Images were obtained using working distance (WD) of 3-5 mm. for 1-20 kV a standard aperture (30 micrometer) was used. The samples were stuck directly on a carbon tape.

Transmission electron microscopy (TEM) imaging was performed using Tecnai T12 transmission electron microscope operated at 120 kV. Sample-preparation: 2.5 μl of each sample was applied to a 300-mesh copper grid coated with holey carbon (Pacific Grid-Tech supplies). Images were process using iTEM 5.2.3553 Olympus Soft Imaging Solutions GmbH.

Tensile tests. For the tensile test experiments, all samples were cut into thin strips of 2-3 mm width, thickness of 30-50 m, and gauge length of ˜20 mm, and measured with an Instron Model 5965 Materials Testing System, equipped with a 50 kN load cell. The deformation rate was 0.2 mm/min. At least 10 specimens of each type were tested. The samples' thickness and width were measured by.

The dimensions of the film were measured using caliber and micrometer.

Bath Sonication was performed using MRC Ultrasonic Cleaner D80H. Model: D80, Operation frequency: 43 KHz, Power: 80Watt.

Thermogravimetric Analysis (TGA) experiments were conducted using the thermal analyzer SDT Q 600 (TA instruments), under air flow (100 ml\min) with a heating rate of 20° C./min. Samples were measured in alumina pans.

Differential Scanning Colorimetry (DSC) Experiments were conducted using DSC Q200 (TA instruments), under N₂ flow (1 ml/min) with a heating rate of 10° C./min. Samples were measured in aluminum T-Zero pans.

Powder X-ray Diffraction (pXRD). Measurements were carried out in reflection mode using a TTRAX III (Rigaku) diffractometer equipped with a scintillation detector and a rotating Cu anode operating at 50 kV and 200 mA in Bragg-Brentano geometry.

Temperature Control measurements were carried out in Ultima III diffractometer equipped with a Cu anode operating at 40 kV and 40 mA in Bragg-Brentano geometry.

Single crystals for X-Ray structure determination: Tyr (20 mg) was dissolved in boiling triple distilled water (20 ml), and the solution was insonated for 5 minutes and needle like Tyrosine crystals precipitated from the saturated solution.

X-ray structure analysis of Tyr was done at temperature 100 K, using Rigaku XtaLAB diffractometer, radiation CuKα, graphite monochromator. 14395 reflections were collected, 2929 independent reflections (R-int=0.0677).

### Example 1

### HEC/Tyr Hybrid Films

### Tyr Films:

L-Tyr (20 mg) was dissolved in boiling DDW (20 ml) for 30 minutes until the solution was clear, the solution was filtered through Polyethersulfone (PES) syringe filter (0.22 μm). The filtered solution was sonicated in a bath sonicator for 3 minutes until a white haze was formed. The vial was placed in ambient conditions to allow the precipitation of Tyr fibrous crystals in ambient conditions.

The mature L-Tyr fibers were deposited over Polyethersulfone (PES) support by vacuum filtration. The films were manually detached from the supports after drying at ambient conditions for 1-3 hours.

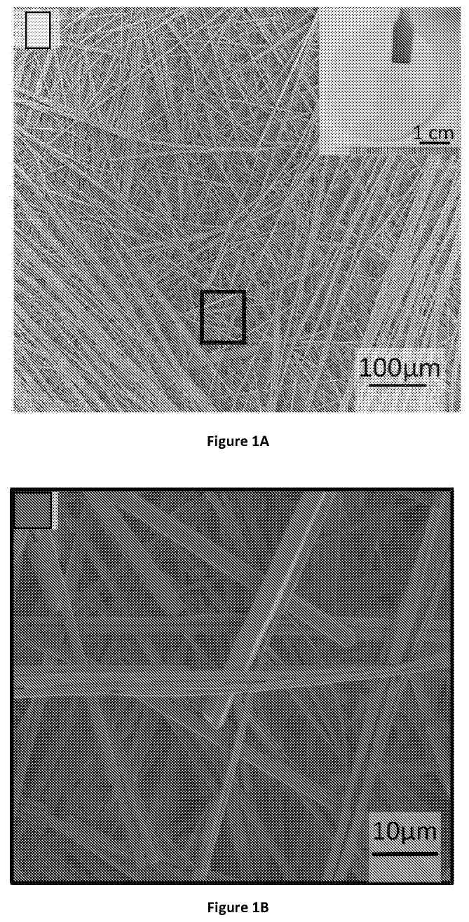

The L-Tyr precipitated into needle like crystals upon cooling with high aspect ratio (greater than 10000), see FIGS. 1A and 1B. Casting sheets from L-Tyr crystals resulted in a cohesive, yet brittle elastic material (elastic modulus: 100±20 MPa; elongation 0.5%). This is due to the fact that the L-Tyr crystals are isotopically oriented and are interconnected by week intermolecular interactions between adjacent crystals.

### Hybrid Preparation:

### Tyr HEC

2-hydroxyethyl cellulose (100 kDa, 100 mg) was dissolved in 6 ml of water for 48 hours.

L-Tyr (20-50 mg) was dissolved in boiling DDW (14 ml) for 30 minutes until the solution was clear, the solution was filtered through Polyethersulfone (PES) syringe filter (0.22 μm).

The hot Tyr solution was added to the HEC fraction, and the mixture was stirred at r.t for 12 hours to allow the crystallization of Tyr. The mature hybrid was either air dried on a polypropylene surface with rectangular (20×10), or circular (diameter:10 cm) shape. The resulting film was manually detached.

Alternatively, the hybrid dispersion was frozen in liquid nitrogen and subsequently lyophilized to yield a foam.

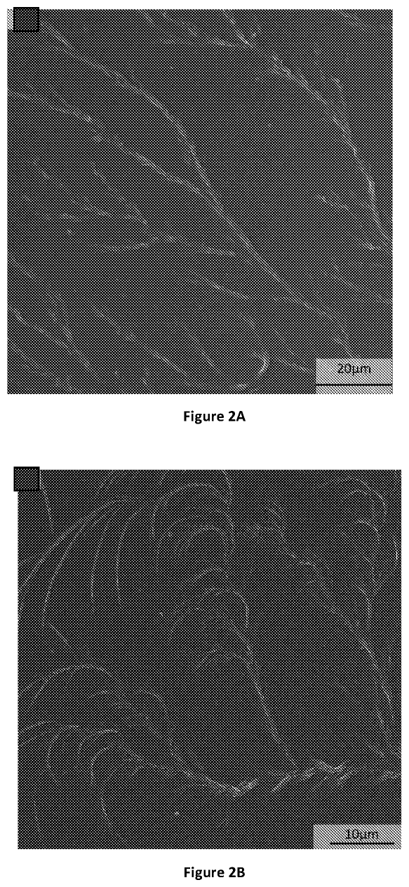

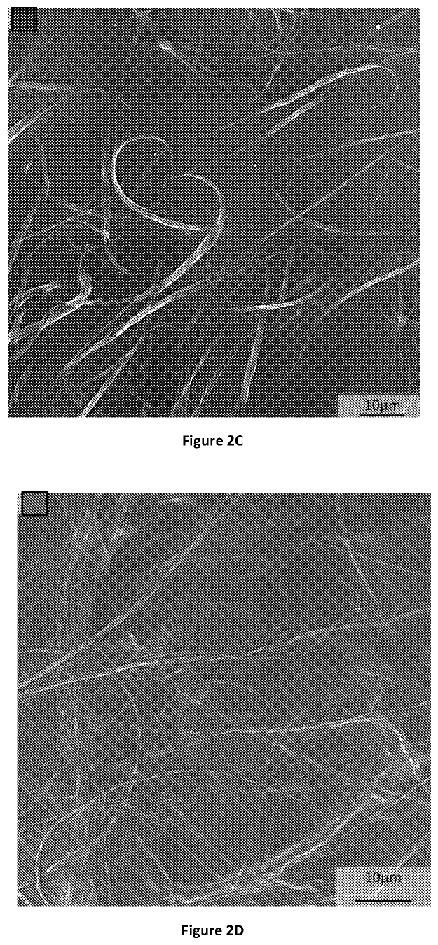

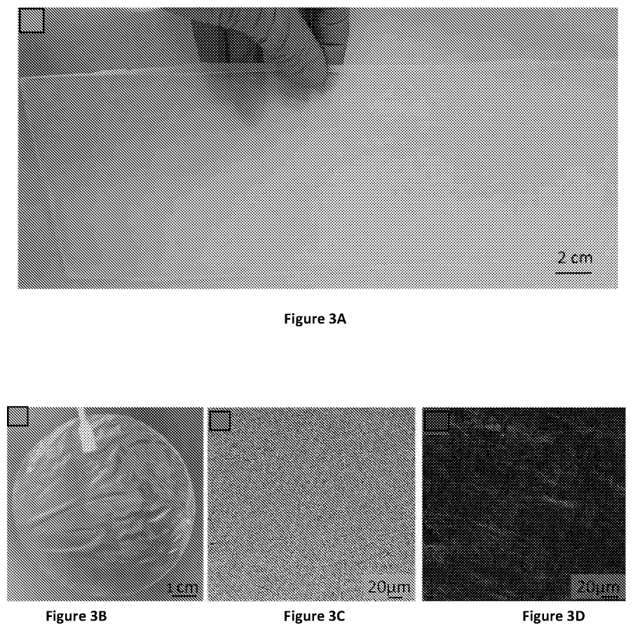

FIGS. 2A-2D show SEM imaging of HEC/Tyr hybrid development from preparation to mature Tyr fibers in the polymer matrix, initially Tyr self-assemble into small needle like crystallites in a coiled “braid-like” superstructure, FIG. 2A. From this state, the crystals grew along the b lattice axis into the mature fiber structure within the polymer matrix (no further morphological change is observed after 12h). In the final step the mature hybrid was either air dried to yield solid films (FIGS. 3A-3D) or freeze dried to yield highly porous foams with tailorable content ratios of HEC to Tyr.

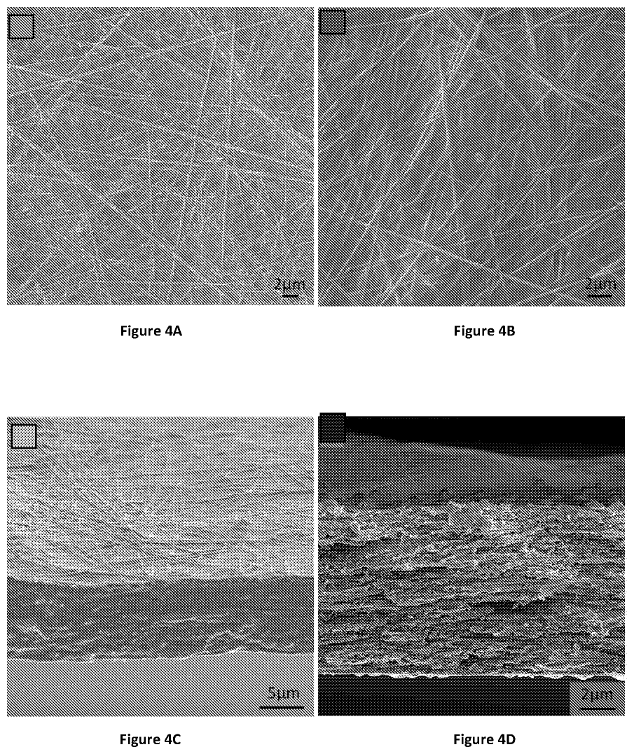

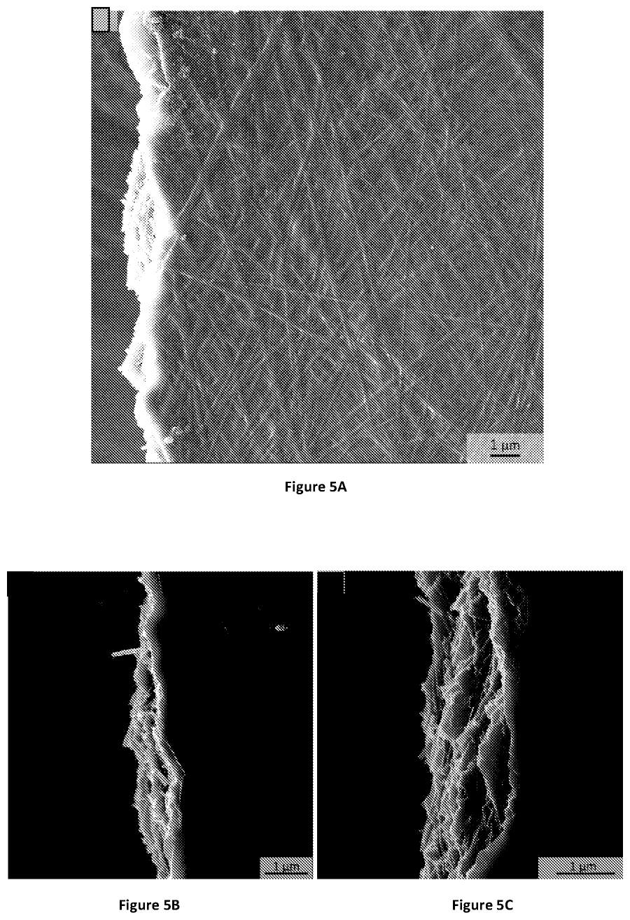

SEM images of the resulting hybrid air dried films showed homogeneous mixture with isotropic distribution of the Tyr crystals throughout the polymer matrix (FIGS. 4A-4D).

### Example 2

### Physical Characterization of the HEC/Tyr Hybrid

Hybridization of HEC with L-Tyr crystals resulted in a dramatic increase of both the elastic modulus and the toughness of the composite comparing to the parent components, as presented in Table 1. Typically, attempts to reinforce soft polymers with strong and stiff fillers such glass and carbon fibers, clay, and nanocrystalline cellulose (NCC), yield composites with enhanced elastic modulus, but with lower ductility and the toughness due to defect formation resulting from the incorporation of the filler in the polymer matrix.

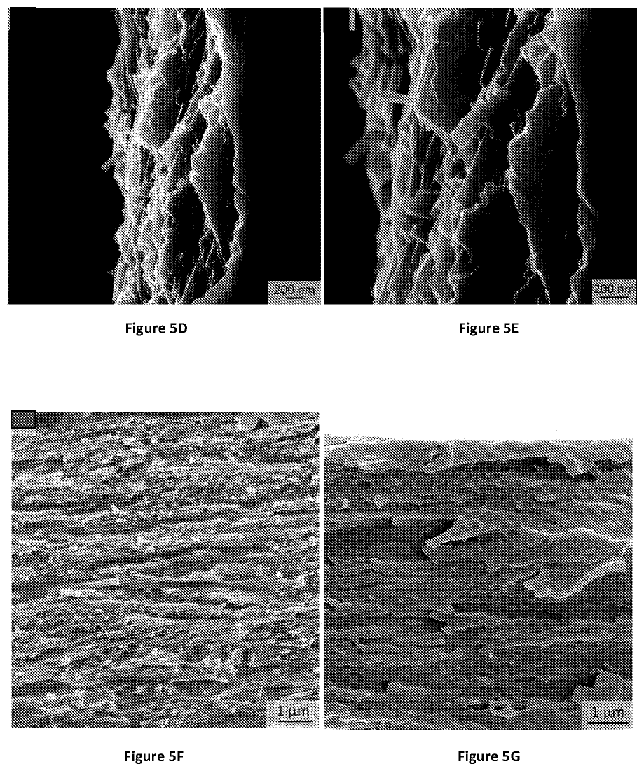

The hybrid HEC/Tyr films described herein are significantly stronger and tougher than the films of their pristine parent components. This is due to the strong intermolecular interactions between the polymer and the crystals. SEM images of the hybrid films after tensile failure test show that there is no phase separation or disentanglement between the crystals and the polymer upon tensile starch (FIG. 5A).

Analysis of the failure cross-section that HEC and L-Tyr revealed that the failure mechanism involves breaking of the Tyr crystals and rapture of HEC simultaneously as evident from the sharp rapture pattern of the HEC polymer, as the raptured HEC matches to the broken “tips” of the Tyr crystals, see FIGS. 5B-5F. The sharp failure pattern and the morphology of the HEC polymer within the hybrid was entirely different from the morphology of pristine HEC film after failure and was uncharacteristic to ductile polymers such as HEC (FIGS. S5g), indicating that the HEC and Tyr were tightly bonded by strong intermolecular interactions.

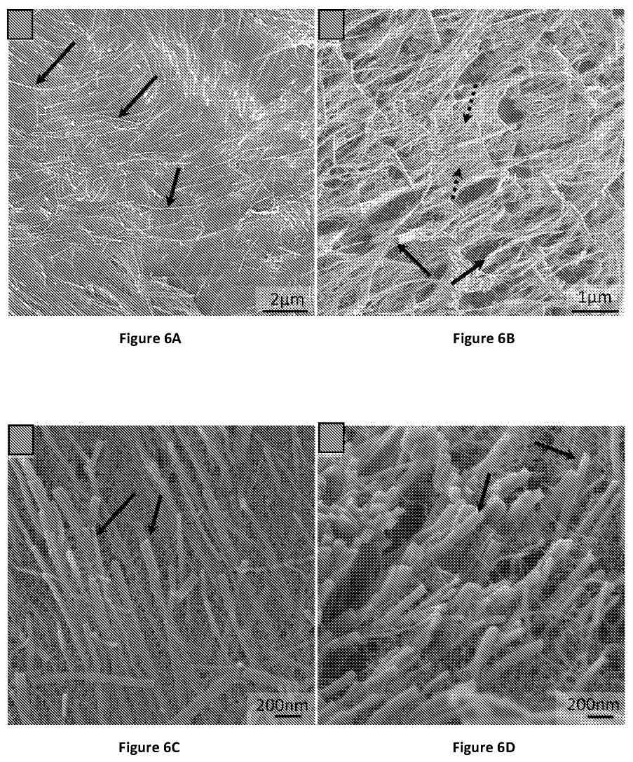

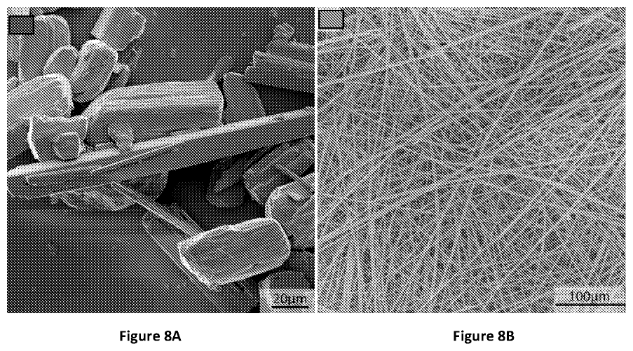

Cryo SEM images of the hybrid showed the HEC fibers enveloped and wrapped around the Tyr crystals forming a homogeneous hybrid interconnected network, FIGS. 6A-6D HEC matrix fluidized and dispersed the Tyr crystals and prevented their aggregation into characteristic Tyr bundles with oriented attachment (FIG. 8A), while the stiff Tyr crystals enhanced the tensile strength of the composite. Moreover, the polymeric lace-like network was entangled with the Tyr crystals, thus preserving, and at some compositions increasing the strain hardening degree until the ductile failure (see Table 1 and FIGS. 1A-1B for HEC/Tyr 100/30 mg, and HEC/Tyr 100/40 mg).

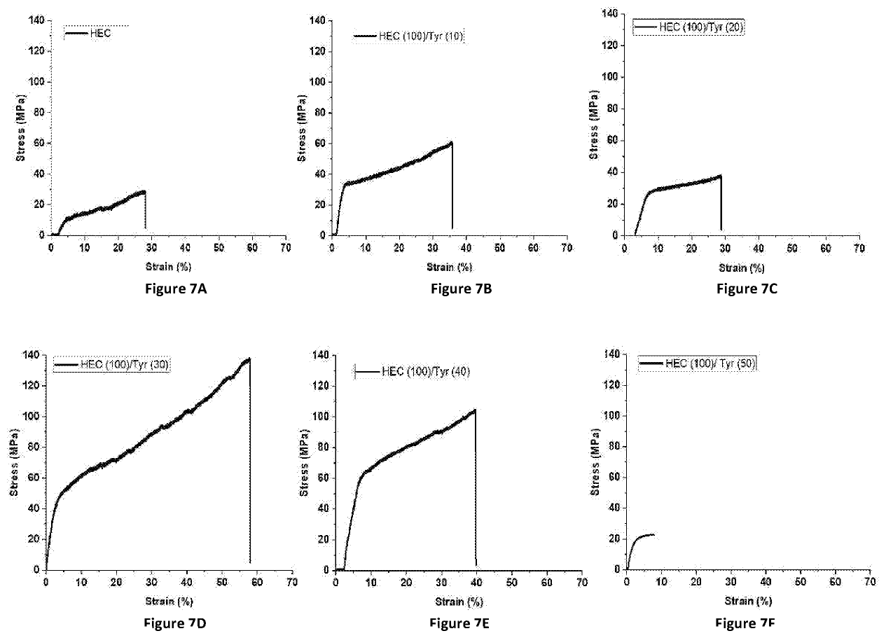

SEM imaging of the foams showed 3D connection between Tyr and the HEC matrix. Neat Tyr crystals were highly robust and elastic, this together with the homogeneous dispersion of the high aspect ratio Tyr crystals in the soft HEC, resulted in non-typical enhancement both in the strength and the toughness of the composite (Table 1 and FIGS. 7A-7F).

TABLE 1
The mechanical properties of bioplastic films made of
Pristine Tyrosine; Pristine HEC and HEC Tyr hybrids.

| | Modulus | Maximum tensile | Elongation | Toughness |
|---|---|---|---|---|
| | (MPa) | stress (MPa) | (%) | (MPa) |
| HEC | 435 ± | 33.2 ± | 31.8 ± | 6.1 ± |
| | 132 | 15.5 | 9.2 | 3.3 |
| HEC/Tyr | 830 ± | 63.6 ± | 29.1 ± | 30.5 ± |
| 10:2 wt/% | 176 | 18.2 | 12.2 | 14.2 |
| HEC/Tyr | 1255.8 ± | 100.6 ± | 55.2 ± | 36.2 ± |
| 10:3 wt % | 257.3 | 22.0 | 10.0 | 12.0 |
| HEC/Tyr | 2090.3 ± | 71.4 ± | 48.4 ± | 20.2 ± |
| 10:4 wt % | 607.9 | 19.3 | 16.8 | 10.6 |
| HEC/Tyr | 1365.9 ± | 20.7 ± | 4.0 ± | 0.5 ± |
| 10:5 wt % | 179.7 | 3.0 | 1.0 | 0.2 |

Composite with HEC/Tyr; 100/30 mg content had the optimal properties, further increasing of Tyr content to HEC/Tyr; 100/40 mg and HEC/Tyr; 100/50 mg increased the elastic modulus while compromising the toughness, probably due to the high viscosity of the hybrids that resulted in films after air drying, see FIGS. 7A-7F. Composite HEC/Tyr; 100/10 mg was prepared via different method, needle-like Tyr fibrous crystals were grown from aqueous supersaturated solution (FIG. 8B), the mature crystals were then mixed the dispersed HEC. In this case a more classic mechanical behavior was observed i.e., the addition of a stiff filler enhanced the tensile modulus while decreasing the toughness.

To demonstrate the robustness of the composite described herein, hybrid stripes were used to lift various weighs, the 40-micron thick stripes of (HEC/Tyr; 100/30 mg) were stable under the load of 66.7 N (6.8 kg) without any visible deformation. These mechanical properties are comparable and even outperform some polymers and blends that are used both for conventional and alternative packaging today. For example: Starch blends, including thermoplastic starch (TPS), L-Polylactic acid (L-PLA), DL-Polylactic acid (DL-PLA), Polyglycolic acid (PGA), blends of PLA/PGA, low density polyethylene (LDPE) and in some modifications of high-density polypropylene. Table 2.

TABLE 2
Mechanical properties for biopolymers and blends that are used today for packaging applications.

| | Elastic | | | |
|---|---|---|---|---|
| | modulus | Strength | Strain | |
| Material | (MPa) | (MPa) | (%) | Reference |
| PLA | 350-3500 | 21-60 | 2.5-6 | Mangaraj, S.; Yadav, A.; Bal, L. M.; Dash, S. K.; Mahanti, |
| | | | | N. K. Application of Biodegradable Polymers in Food |
| | | | | Packaging Industry: A Comprehensive Review. J. Packag. |
| | | | | Technol. Res. 2019, 3 (1), 77-96. |
| | | | | https://doi.org/10.1007/s41783-018-0049-y. |
| PGA | 6000-7000 | 60-100 | 1.5-20 | Saba, N.; Jawaid, M. Recent Advances in Nanocellulose- |
| | | | | Based Polymer Nanocomposites; Elsevier Ltd, 2017. |
| | | | | https://doi.org/10.1016/B978-0-08-100957-4.00004-8. |
| (S)-PLA | 1140-2700 | 15-150 | 3-10 | Mangaraj, S.; Yadav, A.; Bal, L. M.; Dash, S. K.; Mahanti, |
| | | | | N. K. Application of Biodegradable Polymers in Food |
| | | | | Packaging Industry: A Comprehensive Review. J. Packag. |
| | | | | Technol. Res. 2019, 3 (1), 77-96. |
| | | | | https://doi.org/10.1007/s41783-018-0049-y. |
| Racemic PLA | 1000-3450 | 27.5-50 | 2-10 | Abitbol, T.; Rivkin, A.; Cao, Y.; Nevo, Y.; Abraham, E.; |
| | | | | Ben-Shalom, T.; Lapidot, S.; Shoseyov, O. Nanocellulose, |
| | | | | a Tiny Fiber with Huge Applications. Curr. Opin. |
| | | | | Biotechnol. 2016, 39 (I), 76-88. |
| | | | | https://doi.org/10.1016/j.copbio.2016.01.002. |
| PLA/PGA | 1000-4340 | 41-55 | 2-10 | Ashton, H. The Incorporation of Nanomaterials into |
| | | | | Polymer Media. Polym. Nanocomposites Handb. 2009, |
| | | | | 21-44. https://doi.org/10.1201/9781420009804-c3. |
| Chitosan | 135.6 | 32.9 | 54.6 | Rhim, J. W.; Ng, P. K. W. Natural Biopolymer-Based |
| | | | | Nanocomposite Films for Packaging Applications. Crit. |
| | | | | Rev. Food Sci. Nutr. 2007, 47 (4), 411-433. |
| | | | | https://doi.org/10.1080/10408390600846366. |
| TPS/Polystyrene | 190-320 | 8.9-9.5 | 6-6.8 | Altin Karataş, M.; Gökkaya, H. A Review on |
| | | | | Machinability of Carbon Fiber Reinforced Polymer |
| | | | | (CFRP) and Glass Fiber Reinforced Polymer (GFRP) |
| | | | | Composite Materials. Def. Technol. 2018, 14 (4), 318-326. |
| | | | | https://doi.org/10.1016/j.dt.2018.02.001. |
| TPS/LDPE | 380-500 | 10-12 | 6-37 | Wang, Q.; Mynar, J. L.; Yoshida, M.; Lee, E.; Lee, M.; |
| | | | | Okuro, K.; Kinbara, K.; Aida, T. High-Water-Content |
| | | | | Mouldable Hydrogels by Mixing Clay and a Dendritic |
| | | | | Molecular Binder. Nature 2010, 463 (7279), 339-343. |
| | | | | https://doi.org/10.1038/nature08693. |
| TPS/bacterial | 361 | 31 | 5.3 | Julkapli, N. M.; Bagheri, S. Progress on Nanocrystalline |
| cellulose | | | | Cellulose Biocomposites. React. Funct. Polym. 2017, 112, |
| | | | | 9-21. |
| | | | | https://doi.org/10.1016/j.reactfunctpolym.2016.12.013. |
| PHB | 3500-4000 | 40 | 5-8 | Yadav, A.; Mangaraj, S.; Singh, R.; Das, K.; Kumar, N.; |
| | | | | Arora, S. Biopolymers as Packaging Material in Food and |
| | | | | Allied Industry.~2411~Int. J. Chem. Stud. 2018, 6 (2), |
| | | | | 2411-2418. |
| HEC/Tyr | 830-2090.3 | 45.9-100.6 | 25.6-55.2 | Current |
| (100/30 mg) | | | | |

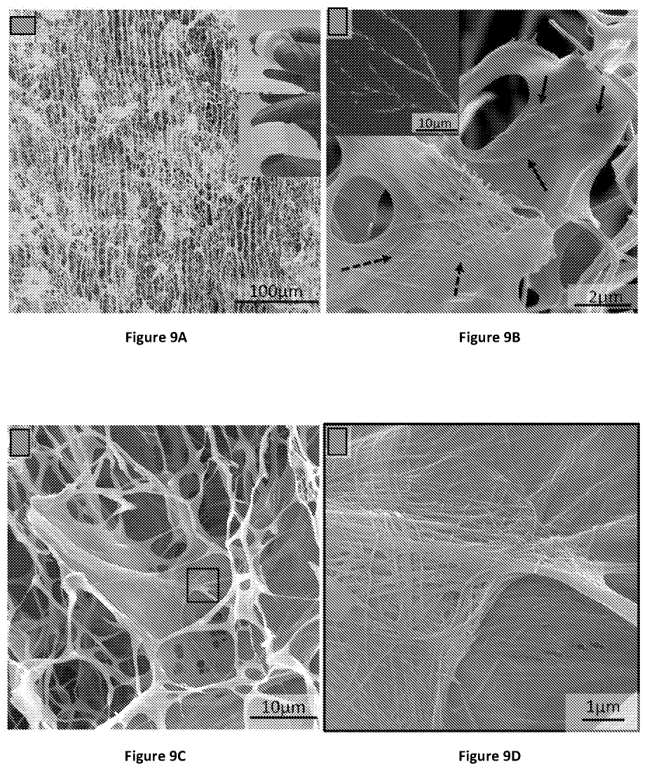

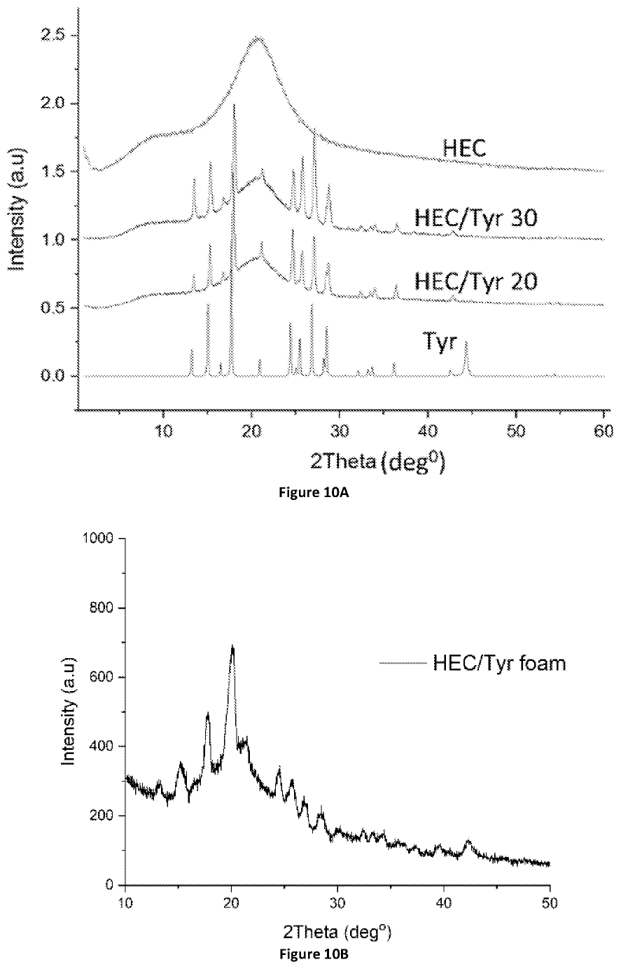

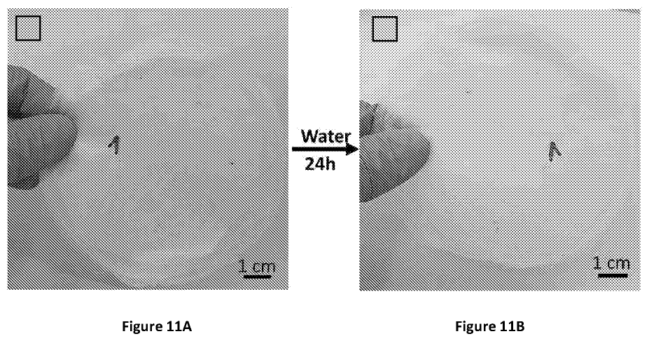

The freeze-dried foams were porous with ordered structure and spatial interconnection between Tyr and the polymer matrix along the rectangular section (FIGS. 9A-9B) and the conical section (not shown), coiled bundles of Tyr that appeared in the fresh prepared hybrids are clearly seen in the foam (FIG. 9B, inset), evidently the growth of Tyr crystals propagate from these initial coil primers into the interconnected structure of the foam. XRD analysis showed two phased hybrid, crystalline Tyr, with mostly amorphous phase of HEC both for the films and the foam, FIG. 10A-10B.

### Thermal Behavior

The thermal behavior of the hybrid was analyzed by thermogravimetric analysis (TGA) and differential scanning calorimetry (DSC).

TGA showed that the hybrid loses surface adsorbed water upon heating, and the hybrid decomposes at 200° C., the content of water was in the range of 8-10 wt % in all compositions and was preserved in the material even after heating the films to 90° C. for 12 hours, or high vacuum drying.

DSC analysis showed that there was no phase transition upon heating up to 150° C. and subsequent cooling, this was confirmed by XRD analysis of the hybrid film at different temperatures, no morphological change was observed upon heating up to 150° C. and subsequent cooling.

Although the HEC/Tyr hybrid was stable in ambient temperature and humidity (no visible change occurs to the films and the foams for at least one year), the hybrid was susceptible to water, as HEC polysaccharide has good solubility.

### Example 3

### Encapsulated HEC/Tyr Hybrid Film

To protect the material, while maintaining the beneficial properties of the hybrid, the films were encapsulated with the hydrophobic films of polycaprolactone (PCL; Mw=80 kD) as protecting layer.

### PCL Films:

PCL (50 mg) was dissolved in CHCl₃, after PCL was fully dissolved, Dimethylformamide (DMF) was added to the solution. The solvents were slowly evaporated on a hot plate (100° C.) using custom designed teflon plate. After all solvents evaporated, the PCL film was allowed to cool and manually detached from the support.

### PCL/HEC/Tyr

Tyr/HEC hybrid films were placed between two PCL films in sandwich-like configuration, the triple composite was sealed by heat-press at 80° C. to yield PCL/HEC/Tyr hybrid film with the HEC/Tyr encapsulated between the PCL layers, the resulting film is shown in FIGS. 9A-9D.

The mechanical properties of the encapsulated film are shown in Table 3. The susceptibility of the protected hybrid was examined by immersing the films in water for 24 hours, subsequent drying and further mechanical analysis. No visible morphological change occurred after the water susceptibility test (FIGS. 11A-11B) Tensile analysis showed that the mechanical behavior of the films after the “water test” was similar to the features of the original ones.

TABLE 3
The mechanical properties of bioplastic films made of Pristine
PCL; PCL/HEC composite and PCL/HEC/Tyr composite.

| | | Maximum | | |
|---|---|---|---|---|
| | Modulus | tensile | Elongation | Toughness |
| Sample | (MPa) | stress (MPa) | (%) | (MPa) |
| PCL 50 mg | 223.9 ± | 32.9 ± | 142.9 ± | 29.3 ± |
| | 32.0 | 22.0 | 66.2 | 7.8 |
| PCL/HEC 100 | 435 ± | 33.2 ± | 31.8 ± | 6.1 ± |
| mg | 132 | 15.5 | 9.2 | 3.3 |
| PCL/HEC100 | 927 ± | 54.6 ± | 20.1 ± | 30.5 ± |
| mg/Tyr 20 mg | 176 | 18.2 | 12.2 | 14.2 |
| PCL/HEC 100 | 1005 ± | 71.9 ± | 34.2 ± | 25.9 ± |
| mg/Tyr 30 mg | 183 | 15 | 10.0 | 8.6 |
| PCL/HEC 100 | 1213 ± | 65.2.9 ± | 34.2 ± | 25.9 ± |
| mg/Tyr 40 mg | 201 | 15 | 10.0 | 8.6 |
| PCL/HEC 100 | 1325.6 ± | 25.8 ± | 5.4 ± | 1.8 ± |
| mg/Tyr 50 mg | 162 | 6.7 | 1.6 | 0.5 |

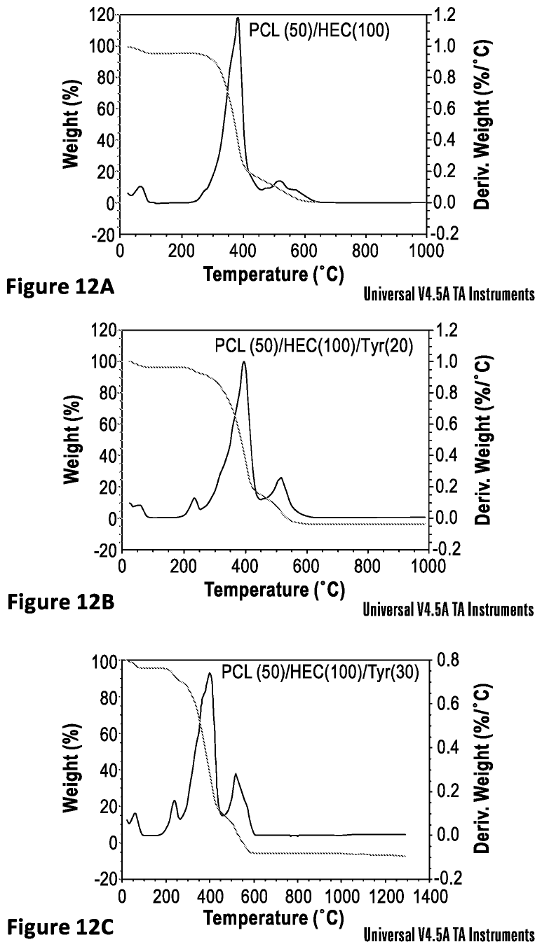

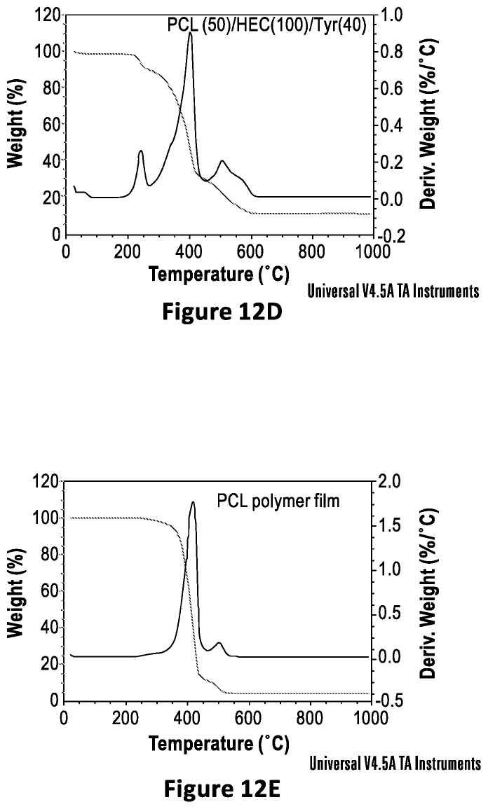

Thermal properties of the protected hybrid were analyzed by TGA, FIGS. 12A-12E. A qualitative observation of the biodegradation in domestic composter; no visible residue of the unprotected films was observed within one month. (Diameter: 10 cm; 40-50 micron thick), while in the case of PCL protected film, clear evidence of degradation is visible by naked eye.

### Example 4

### Agar/Tyr Composite

Agarose (from algae, 100 mg) was dissolved in 10 ml of boiling water. L-Tyr (20-50 mg) was dissolved in boiling DDW (10 ml) for 30 minutes until the solution was clear, the solution was filtered through Polyethersulfone (PES) syringe filter (0.22 μm).

The hot L-Tyr solution was added to the hot Agarose fraction, and the mixture was stirred at r.t for 12 hours to allow the crystallization of Tyr. The mature hybrid was either air dried on a polypropylene surface with rectangular (20×10), or circular (diameter:10 cm) shape. The resulting film was manually detached.

Agar/Tyr hybrids with enhanced mechanical robustness were obtained, see FIGS. 13A-13E.

### Example 5

### Alginate/Tyr Hybrid/Hydrogel

### Tyrosine Hydrogel

50 mg of L-Tyrosine was mixed in 6 ml of ddw in a glass vial under stirring and boiling until a completely particle-free transparent solution was observed. The magnetic stirrer was rapidly removed, and the Tyrosine solution was left at room temperature for overnight. A turbid solution appears in a few seconds, and a stable solid-like matter which did not flow under shear force formed after 1 h or longer times.

### Tyrosine Aerogel

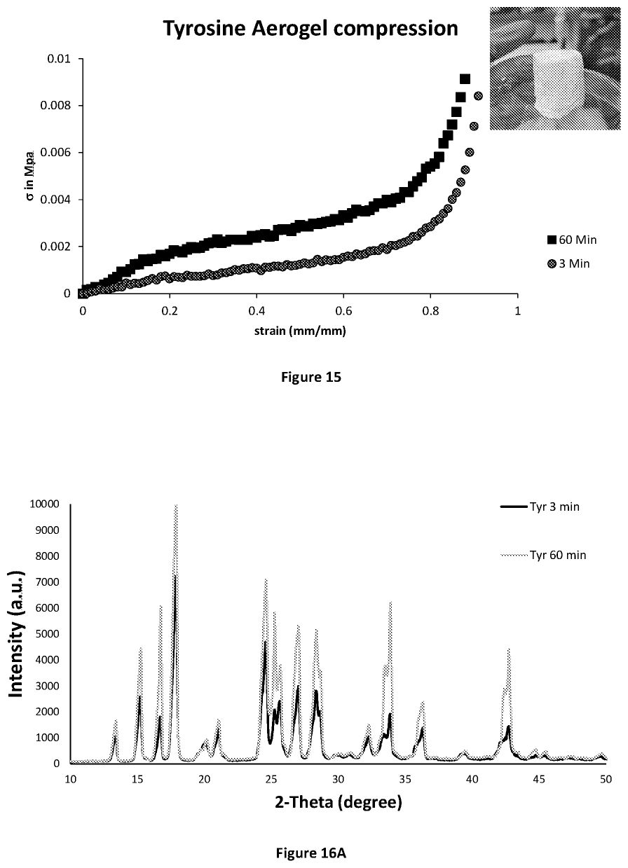

A vial containing mature L-Tyrosine hydrogel described above went through the lyophilization process. Briefly, the glass vial was immersed into a liquid nitrogen bath for 1 min. Then the frozen Tyrosine hydrogel is placed in the lyophilization system, keeping the sample temperature of −80° C. under low-pressure conditions. After overnight lyophilization, dry water-free Tyrosine aerogel was obtained. (FIGS. 15 and 16A-16B)

### Tyrosine/Alginate Hydrogel

Alginate (50 mg) was mixed with 2.5 ml of ddw under stirring for 1 hr. L-Tyrosine (50 mg) was dissolved in 5 ml ddw in a glass vial under stirring and boiling until a completely particle-free transparent solution was observed. The boiling tyrosine solution is then poured into the Alginate solution and left for cooling and crystallization overnight at RT. The Tyrosine/Alginate gel then was frozen using liquid nitrogen and crosslinked by immersing it in 10 ml of 100 mg/ml CaCl₂ solution. After 12 h, the crosslinked gel was washed twice with ddw.

### Tyrosine/PCL (Polycaprolactone) Aerogel

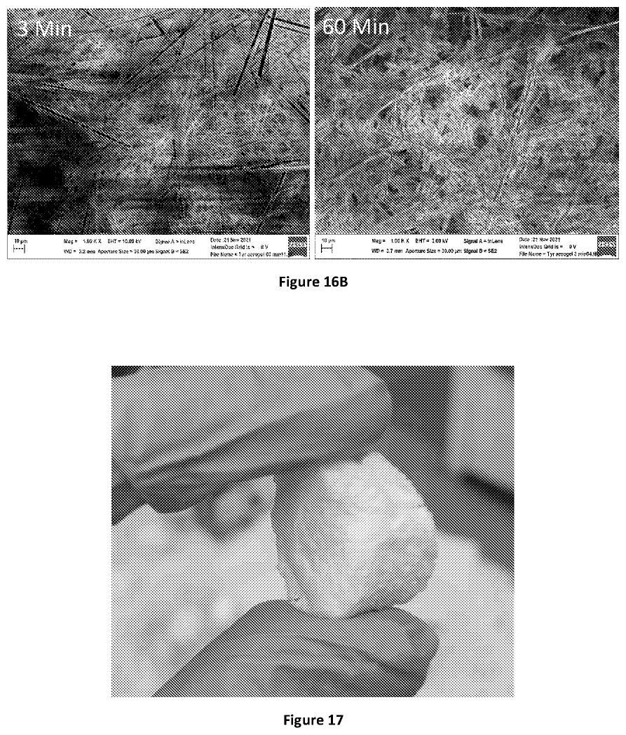

Different concentrations (10-50% w/w) of PCL dissolved in DCM:Hexane solution (1:1, v/v) was poured onto the mentioned above Tyrosine aerogel. Due to its high volatility, DCM evaporates rapidly. The remained hexane evaporated at RT with minor shrinkage of the aerogel due to the hexane's low surface tension. (FIG. 17).

### Example 6

### Biodegradation Study of the Composites

In order to determine the biodegradation of the composites provided herein a film comprising Composite 1 (Tyr/HEC (about 30 microns) as described in Example 1) was prepared and a film comprising Composite 2 (PCL/Tyr/Hec as described in Example 3) was prepared.

The films were grinded in a cariogenic mill. The grinded films were sieved to the size of 300-600 μm. 1.25 gr of each composite entered a bioreactor for biodegradation test. The reference material was cellulose powder (1.25 gr˜20 micron in each vessel).

The test system include (Table 4):
2 blank vessels with Compost extract and vermiculite only.
2 Reference vessels with Compost extract and vermiculite +Cellulose
2 test vessels containing Compost extract and vermiculite+Composite 1
2 test vessels containing Compost extract and vermiculite+Composite 2

TABLE 4
Experimental set up

| | | | Compost + |
|---|---|---|---|
| Flask | Test material | Reference material | Vermiculite |
| Blank | | | + |
| Blank | | | + |
| Reference | | + | + |
| Reference | | + | + |
| Composite 1 | + | | + |
| Composite 1 | + | | + |
| Composite 2 | + | | + |
| Composite 2 | + | | + |

The measurements were conducted according to ISO 17556 procedure: “Plastics-Determination of the ultimate aerobic biodegradability in soil by measuring the oxygen demand in a respirometer or the amount carbon dioxide of evolved”. The CO₂ was collected and analyzed in 100 NaH solution.

### RESULTS

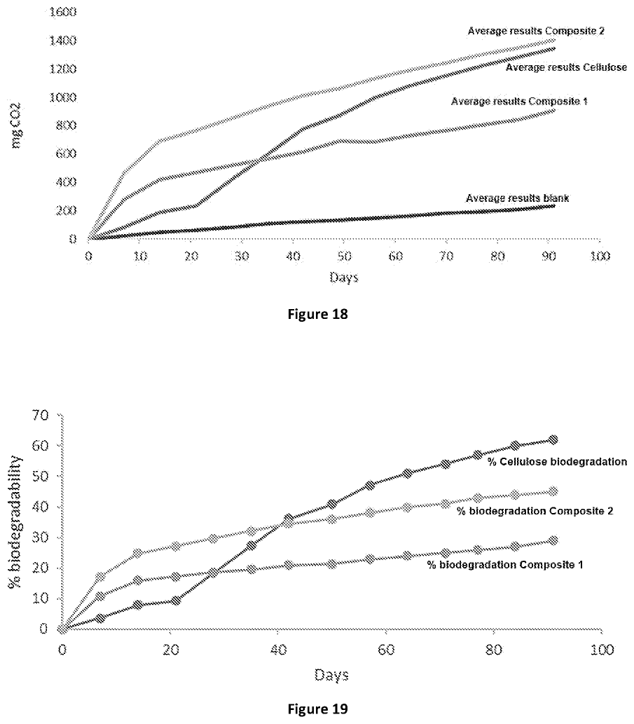

The Biodegradation results are presented in the Tables 5 and 6 and in FIGS. 18 and 19.

TABLE 5
Biodegradation expressed as released CO₂ (mg) (FIG. 18)

| | Average results | Average results | Average results | Average results |
|---|---|---|---|---|
| days | blank | cellulose | composite 1 | composite 2 |
| 0 | 0 | 0 | 0 | 0 |
| 7 | 21 | 86 | 278 | 456 |
| 14 | 48 | 191 | 423 | 690 |
| 21 | 65 | 233 | 468 | 765 |
| 28 | 86 | 418 | 522 | 852 |
| 35 | 106 | 597 | 566 | 938 |
| 42 | 124 | 775 | 617 | 1014 |
| 49 | 135 | 873 | 693 | 1066 |
| 56 | 150 | 997 | 689 | 1133 |
| 63 | 166 | 1084 | 733 | 1193 |
| 70 | 183 | 1152 | 769 | 1246 |
| 77 | 194 | 1224 | 808 | 1305 |
| 84 | 211 | 1282 | 841 | 1351 |
| 91 | 232 | 1343 | 909 | 1404 |

TABLE 6
Biodegradation degree (%) (FIG. 19)

| | % cellulose | % biodegradation | % biodegradation |
|---|---|---|---|
| days | biodegradation | Composite 1 | Composite 2 |
| 0 | 0 | 0 | 0 |
| 7 | 4 | 11 | 17 |
| 14 | 8 | 16 | 25 |
| 21 | 9 | 17 | 27 |
| 28 | 19 | 19 | 30 |
| 35 | 27 | 20 | 32 |
| 42 | 36 | 21 | 35 |
| 50 | 41 | 21 | 36 |
| 57 | 47 | 23 | 38 |
| 64 | 51 | 24 | 40 |
| 71 | 54 | 25 | 41 |
| 77 | 57 | 26 | 43 |
| 84 | 60 | 27 | 44 |
| 91 | 62 | 29 | 45 |

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A biodegradable composite comprising a biodegradable polymer and bio-crystals, wherein the bio-crystals are in a concentration of between 1 wt % to 50 wt % of the biodegradable polymer; wherein the bio-crystal comprises crystaline uric acid, amino acids, purine, guanine, xanthenes, isoxanthenes, indigo, porphyrin, or any combination thereof.

2. The composite according to claim 1, wherein the biodegradable polymer comprises 2-hydroxyethyl cellulose (HEC), cellulose derivative, cellulose acetate, poly(lactic acid) (PLA), poly(glycolic acid) (PGA), PLA/PGA, Chitosan, thermoplastic starch (TPS)/polystyrene, TPS/low density polyethylene (LDPE), TPS/bacterial cellulose, agarose (Agar) polysaccharide, Polyhydroxybutyrate(PHB), alginate, polysaccharides, cellulose derivatives or any combination thereof.

3. The composite according to claim 2, wherein the biodegradable polymer is HEC.

4. The composite of claim 2, wherein the poly(lactic acid) (PLA) is poly(L-lactic acid)(PLLA), poly(D-lactic acid)(PDLA) or racemic PLA.

5. The composite according to claim 1, wherein the amino acid is tyrosine.

6. The composite according to claim 1, wherein the composite comprises HEC and L-tyrosine nanocrystals.

7. The composite according to claim 1, wherein the composite comprises agar and L-tyrosine crystals.

8. The composite according to claim 1, wherein the bio-crystals are dispersed homogeneously within the biodegradable polymer.

9. The composite according to claim 1, wherein the composite degrades/compostable by 15%-50 wt % after 30 days.

10. The composite according to claim 1, wherein the composite is further encapsulated by hydrophobic film.

11. The composite according to claim 10, wherein the hydrophobic film comprises polycaprolactone (PCL).

12. The composite of claim 10, wherein the encapsulated composite maintains the same mechanical properties as the non-encapsulated composite.

13. The composite of claim 10, wherein the encapsulated composite maintains the same mechanical properties as the non-encapsulated composite.

14. The composite according to claim 1 wherein the composite provides improved mechanical properties compared to the biodegradable polymer alone.

15. The composite according to claim 1, wherein the composite is a film, a gel, an aerogel, xerogel, a hydrogel a foam or a bulk 3D structure.

16. The composite according to claim 1, wherein the composite is prepared by melt compounding or by melt extrusion.

17. A biodegradable packaging material, structural/construction material comprising the composite according to claim 1.

18. A coating material comprising the composite according claim 1.
